(19) United States
(12) Patent Application Publication
(10) Pub. No.: US 2008/0098875 A1
(43) Pub. Date: May 1, 2008

(54) MUSIC PLAYBACK SYSTEMS AND METHODS

(75) Inventors: Shiau-Jiuan Chen, Taipei (TW); Jia-Han Li, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/673,620

(22) Filed: Feb. 12, 2007

(30) Foreign Application Priority Data
Oct. 31, 2006 (TW) 95140197

(51) Int. Cl. G10H 7/00

(52) U.S. Cl. 84/609

(57) ABSTRACT

Music playback systems and methods. The system comprises a first storage device and a playback device. The first storage device comprises a plurality of first songs, and a first database storing song information of respective first songs. The playback device comprises a processing module. When the first storage device couples to the playback device, the processing module loads the first database to a temporary space, thus to be aware of the first songs in the first storage device, and provides the first songs on the playback device for selection and playback.

### BACKGROUND OF THE INVENTION

1. Field of the Invention

The invention relates generally to music playback systems and methods, and, more particularly, to music playback systems and methods for use in playback devices with external storage devices.

2. Description of the Related Art

Portable devices have become commonplace, due to portability and multi-functionality. Generally, portable devices have become more and more advanced, with built-in music playback capability. Users can upload music files to a built-in storage device of a portable device, and play back the music via the portable device.

To store data for various applications, portable devices have connection ports coupling to external storage devices. Users can store related data in the external storage devices, and couple the external storage devices to the connection ports for application access. Similarly, users can store favorite music files to the external storage devices, such that music playback application can read and play back the music files from the external storage devices.

In conventional playback systems, however, a portable device must scan external storage devices for music files therein if the external storage devices are coupled to the portable device. After the portable device establishes corresponding file paths in an internal song information database, the music files in the external storage device can be correctly used. If the external storage device has a large number of music files, it is time-consuming to scan all music files. Additionally, when the external storage device is removed from the portable device, corresponding paths of music files are not removed from the song information database synchronously, resulting in possible playback error.

### BRIEF SUMMARY OF THE INVENTION

Music playback systems and methods are provided.

An embodiment of a music playback system comprises a first storage device and a playback device. The first storage device comprises a plurality of first songs, and a first database storing song information of respective first songs. The playback device comprises a processing module. If the first storage device couples to the playback device, the processing module loads the first database to a temporary space, thus to be aware of the first songs in the first storage device, and provides the first songs on the playback device for selection and playback.

In an embodiment of a music playback method for use in a playback device, a first storage device couples to the playback device. The first storage device comprises a plurality of first songs, and a first database storing song information of respective first songs. The song information of respective first songs in the first database is loaded to a temporary space, thus to be aware of the first songs in the first storage device. One song information listing in the temporary space is selected for playback.

Music playback systems and methods may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a music playback system;

FIG. 2 is a flowchart of an embodiment of a music upload method;

FIG. 3 is a flowchart of an embodiment of a music playback method;

FIG. 4A is a schematic diagram illustrating an embodiment of a playback device without an external storage device; and

FIG. 4B is a schematic diagram illustrating an embodiment of a playback device with an external storage device.

### DETAILED DESCRIPTION OF THE INVENTION

Music playback systems and methods are provided.

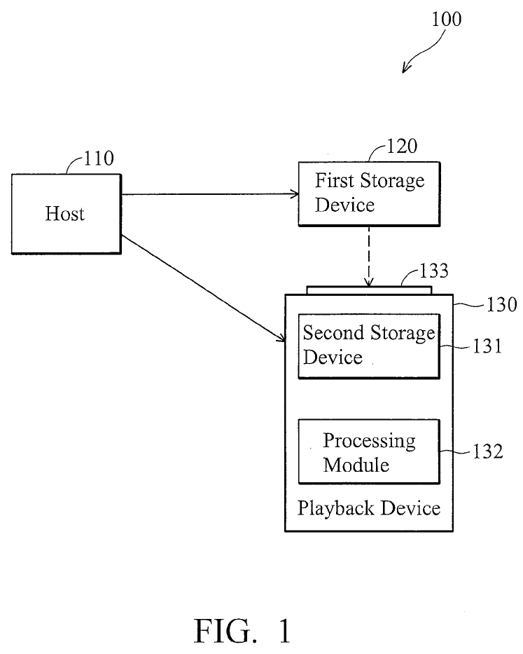

FIG. 1 illustrates an embodiment of a music playback system.

The music playback system 100 comprises a host 110, a first storage device 120, and a playback device 130. The host 110 may be a computer system comprising several songs. The host 110 can upload the songs to the first storage device 120 and/or the playback device 130. The first storage device 120 may be an external memory card. The playback device 130 comprises a second storage device 131, a processing module 132, a connection port 133, and a display unit (not shown in FIG. 1). The second storage device 131 may be a built-in memory of the playback device 130. The processing module 132 performs the music playback methods, and related detail is discussed later. The connection port 133 receives couple of the first storage device 120. It is noted that the playback device 130 further comprises a temporary space (not shown) temporarily storing related data.

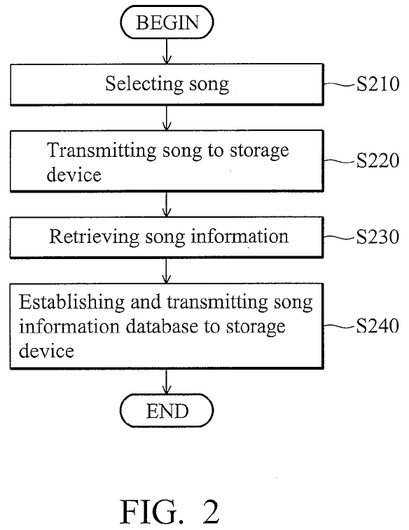

FIG. 2 is a flowchart of an embodiment of a music upload method.

In step S210, at least one specific song is selected from the host 110. It is understood that the host 110 has a song management application (not shown) displaying all songs in the host 110. Users can select songs using the song management application. After the song is selected, in step S220, the host 110 transmits the selected song to the storage device via the song management application. It is noted that the destination of transmission such as the first storage device 120 or the second storage device 131 of the playback device 130 can be set in the song management application. In step S230, song information of the song is retrieved during transmission, and in step S240, a song information database is established according to the retrieved song information, and the song information database is stored to the storage device according to a predefined path. It is understood that the song information comprises title, ID, lyric information, melody information, performer, file path, filename, song classification, song length, file size, language code, type of song, number of songs, and others.

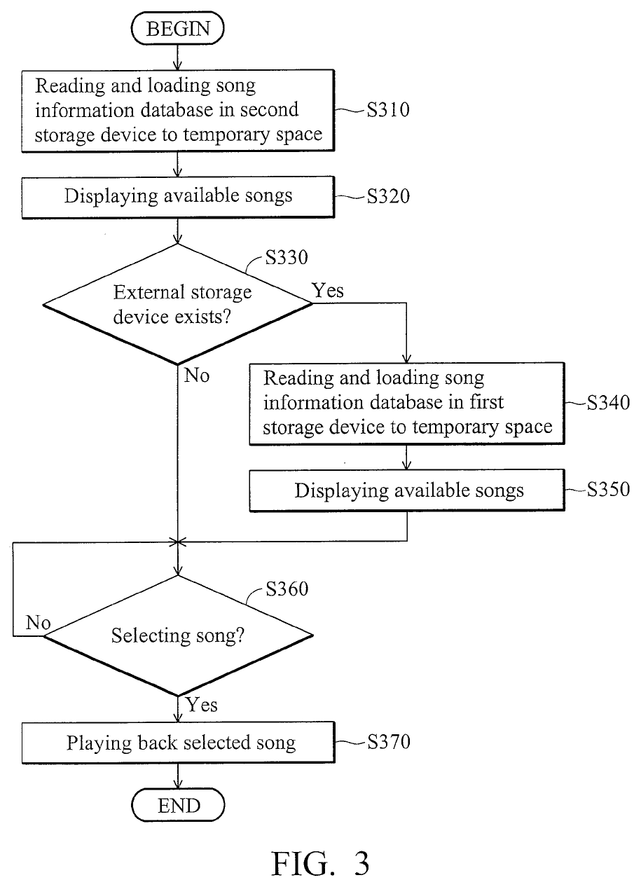

FIG. 3 is a flowchart of an embodiment of a music playback method.

In step S310, the processing module 132 reads a song information database from the second storage device 131 according to a predefined path, and loads the song information database to the temporary space, thus to be aware of the songs in the second storage device 131, and in step S320, displays the available songs via the display unit. In step S330, it is determined whether an external storage device is coupled to the playback device 130. If not, the procedure goes to step S360. If so, in step S340, the processing module 132 reads a song information database from the first storage device 120 according to a predefined path, and loads the song information database to the temporary space, thus to be aware of the songs in the first storage device 120, and in step S350, displays the available songs in the display unit. It is understood that the processing module 132 can be aware of the songs in the first storage device 120 by directly reading the song information database in the first storage device 120 without scanning the entire first storage device 120. In step S360, it is determined whether song information corresponding to a song is selected. If not, the procedure remains at step S360. If so, in step S370, the selected song is played back. In some embodiments, the processing module 132 can obtain the file name and the file path of the selected song from the song information database, and loads the selected song from the storage device accordingly.

It is understood that the songs in the first storage device 120 can be added to the second storage device 131 according to various requirements. In some embodiments the songs in the first storage device 120 are not added to the second storage device 131, but loaded to the playback device 130 for playback if they are selected. In some embodiments, if specific song information corresponding to the first storage device 120 in the temporary space is selected, the selected song information is added to the song information database of the second storage device 131, and the song corresponding to the selected song information is transmitted to the second storage device 131. Additionally, if the first storage device 120 is removed from the playback device 130, the processing module 132 also removes the song information corresponding to the songs in the first storage device 120 from the temporary space.

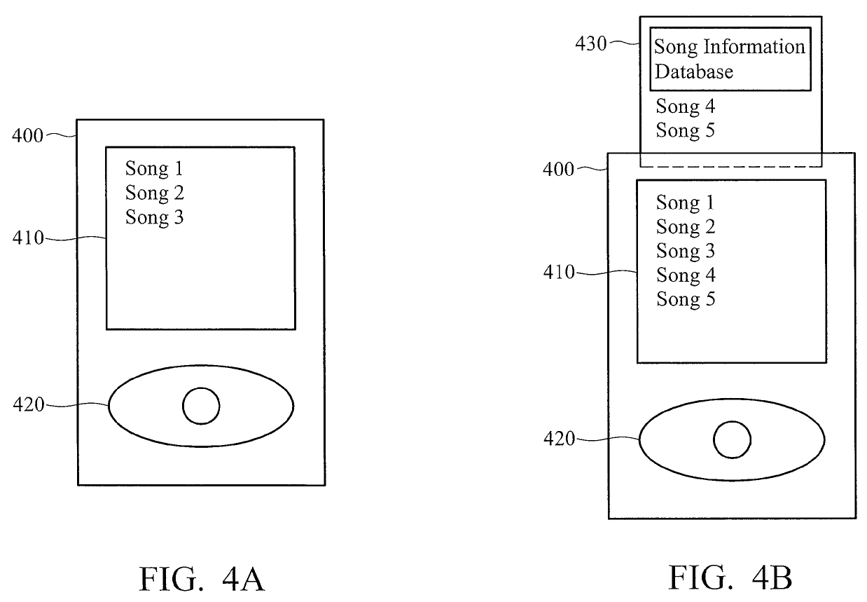

In an example, playback device 400 without external storage device as shown in FIG. 4A, where a built-in storage device of the playback device 400 comprises songs 1, 2 and 3, comprises a display unit 410 and a selection device 420. The display unit 410 can display the song information corresponding to the songs in the built-in storage device. An external storage device 430 comprises songs 4 and 5, and a song information database correspondingly. If the external storage device 430 couples to the playback device 400, the processing module of the play back device 400 directly reads the song information database from the external storage device 430, and loads the song information database to the temporary space, thus to be aware of songs 4 and 5 in the external storage device 430. The processing module displays the song information of songs 4 and 5 in the display unit 410, as shown in FIG. 4B. Selection device 420 of the playback device 400 can be used to select specific songs for playback. It is understood that if the external storage device 430 is removed from the playback device 400, only song information corresponding to the songs in the built-in storage device is displayed in the display unit 410.

Music playback systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. A music playback system, comprising:
a first storage device comprising a plurality of first songs, and a first database storing song information of respective first songs; and
a playback device comprising:
a processing module loading the first database to a temporary space if the first storage device couples to the playback device, thus to be aware of the first songs in the first storage device, and providing the first songs on the playback device for selection and playback.

2. The system of claim 1 wherein the playback device further comprises a second storage device comprising a plurality of second songs, and a second database storing song information of respective second songs, and the processing module loads the second database to the temporary space, thus to be aware of the second songs in the second storage device, and providing the second songs on the playback device for selection and playback.

3. The system of claim 2 wherein the processing module further retrieves and stores the first songs to the second storage device according to the song information of the first songs in the playback device.

4. The system of claim 2 wherein the processing module further removes the song information of the first songs from the temporary space if the first storage device is removed from the playback device.

5. The system of claim 1 further comprising a host transmitting the first songs to the first storage device, retrieving the song information of respective first songs from the first songs, and establishing the first database accordingly.

6. The system of claim 5 wherein the first database is stored at a predefined path in the first storage device.

7. The system of claim 1 further comprising a display unit displaying the song information of respective first songs.

8. The system of claim 4 further comprising a display unit displaying the song information of respective first songs and second songs, and only displaying the song information of respective second songs if the first storage device is removed from the playback device.

9. The system of claim 1 wherein the processing module obtaining a file path and a file name of the selected first song from the first database, and loading the selected first song from the first storage device for playback if one of the first songs is selected.

10. A music playback method for use in a playback device, comprising:
receiving from a first storage device comprising a plurality of first songs, and a first database storing song information of respective first songs;
loading the first database to a temporary space, thus to be aware of the first songs in the first storage device;
selecting one song information listing of the first songs for playback; and
loading the corresponding first song according to the selected song information.

11. The method of claim 10 further comprising:
receiving from of a second storage device comprising a plurality of second songs, and a second database storing song information of respective second songs;
loading the second database to the temporary space, thus to be aware of the second songs in the second storage device; and
selecting one song information listing of the second songs for playback.

12. The method of claim 11 further comprising selecting one song information listing of the first songs in the temporary space, and transmitting the selected first song to the second storage device.

13. The method of claim 12 further comprising selecting one song information listing of the first songs in the temporary space, and adding the selected song information to the second database.

14. The method of claim 11 further comprising removing the song information of the first songs from the temporary space if the first storage device is removed from the playback device.

15. The method of claim 14 further comprising storing the first database at a predefined path in the first storage device.

16. The method of claim 10 further comprising:
transmitting the first songs to the first storage device by a host;
retrieving the song information of respective first songs from the first songs; and
establishing the first database accordingly.

17. The method of claim 11 further comprising:
transmitting the second songs to the second storage device in the playback device by a host;
retrieving the song information of respective second songs from the second songs; and
establishing the second database accordingly.

18. The method of claim 10 further comprising displaying the song information of respective first songs via a display unit.

19. The method of claim 13 further comprising:
displaying the song information of respective first songs and second songs via a display unit; and
only displaying the song information of respective second songs if the first storage device is removed from the playback device.

20. The method of claim 10 wherein the step of loading the selected first song from the first storage device for playback according to a file path and a file name stored in the selected song information.
